(19) United States
(12) Patent Application Publication
(10) Pub. No.: US 2014/0157672 A1
(43) Pub. Date: Jun. 12, 2014

(54) Door opener including a detector configured to detect positions of mobile structural components of the door opener

(71) Applicants: Kai Gröne, Witten (DE); Marc-André Schneider, Ennepetal (DE); Michael Suberg, Remscheid (DE)

(72) Inventors: Kai Gröne, Witten (DE); Marc-André Schneider, Ennepetal (DE); Michael Suberg, Remscheid (DE)

(21) Appl. No.: 14/233,693

(22) PCT Filed: Mar. 12, 2012
(86) PCT No.: PCT/EP2012/002272

§ 371 Date: Jan. 17, 2014

(30) Foreign Application Priority Data
Jul. 19, 2011 (DE) 10 2011 051 946.7

(51) Int. Cl. E05F 15/20

(52) U.S. Cl. CPC E05F 15/20
USPC 49/31

(57) ABSTRACT

A door opener includes a detector configured to detect a relative and/or absolute position of mobile structural components of the door opener. The detector has at least one magneto-sensitive sensor configured to be accommodated in a carrier of at least one printed circuit board, the magneto-sensitive sensor being at least partially disposed within the printed circuit board. Contacts of the magneto-sensitive sensor are coupled to the at least one printed circuit board, either directly or via a conductor foil. The magneto-sensitive sensor cooperates with at least one magnet at a structural component, which is mobile in relation to the magnet, to generate a position signal.

### CROSS-REFERENCE TO RELATED APPLICATIONS

This is a U.S. national stage of application No. PCT/EP2012/002272, filed on 30 May 2012, which claims priority to the German Application No. 10 2011 051 946.7, filed 19 Jul. 2011, the content of both incorporated herein by reference.

### BACKGROUND OF THE INVENTION

1. Field of the Invention The present invention relates to a door opener including a detector configured to detect relative and/or absolute positions of mobile structural components of a door opener.

2. Related Art

Conventional door openers use printed circuit boards to detect conditions of the door opener, which boards have electronic structural components such as for example, sensors, which are disposed on the printed circuit board in a surface-mounted design. In the surface-mounted design, electronic structural components are soldered directly to a printed circuit board by solderable contact surfaces. This is advantageous in that the structural height of the printed circuit board with the electronic structural components negatively affects the overall structural height of the door opener.

In a conventional surface-mounted design, the sensors are damaged by magnets moving by, if insufficient distance is maintained between the magnet and the sensor, which is disadvantageous in that the structural height is negatively affected.

### SUMMARY OF THE INVENTION

Therefore, it is an object of the present invention to provide a door opener including a detector configured to detect conditions of the door opener, which detector can be disposed in the door opener with the least space requirement.

In accordance with one aspect of the present invention, a detector configured to detect the position of components of a door opener includes at least one magneto-sensitive sensor, which is incorporated, at least partially, into a printed circuit board and the contacts thereof are connected directly to a printed circuit board or to a conductor foil. The magneto-sensitive sensor cooperates with at least one magnet disposed at a structural component, which is mobile with regard to the sensor for producing a position signal.

An advantage of the inventive embodiment according to this aspect is that the structural height of the printed circuit board, including its electronic components, such as sensors for example, can be kept small, wherein, with an even more reduced space requirement, the additionally required structural components for detecting the positions of the mobile structural components of the door opener can be incorporated.

According to advantageous aspect of the invention, if the printed circuit board has at least one opening into which the sensor protrudes at least partially. Thus, in the area of the printed circuit board, mounting space is provided, which can be utilized by the electronic components, such as a sensor, for example.

According to another advantageous aspect, the magnet is disposed in or at a structural component. Thus, positions of structural components can be detected on account of operative connections between the magnets and the magneto-sensitive sensors.

According to another advantageous aspect, the mobile structural component includes the magnet. The door opener is thus enabled to detect positions of mobile structural components in conjunction with magneto-sensitive sensors.

According to another advantageous aspect, the magneto-sensitive sensor is configured as an encapsulated sensor in a surface-mounted design. This allows for placing components onto the printed circuit board in a simple manner.

In another advantageous aspect, the magneto-sensitive sensor can be accommodated by a carrier. The magneto-sensitive sensor, with the carrier, is mountable to the printed circuit board in a clamping manner, while protruding, at least partially, into it.

According to another advantageous aspect, the carrier has a reception. The reception almost has the shape of the magneto-sensitive sensor, whereby the magneto-sensitive sensor is positively retained.

According to another advantageous aspect, the printed circuit board has an opening for positively accommodating the carrier. On account of the carrier, a simple mounting of the magneto-sensitive sensor is thus possible.

According to another advantageous aspect, the carrier is provided by which the magneto-sensitive sensor positively at least partially protrudes into the wall thickness of the printed circuit board. Thus a low structural height can be achieved in this way.

According to another advantageous aspect, the carrier is made from a plastic-like material. Thereby, the carrier can be manufactured in a simple manner.

According to another advantageous aspect, the printed circuit board, in at least one partial section, has a notch into which a magneto-sensitive sensor protrudes at least partially. It is thereby possible to likewise utilize border areas of the printed circuit board in order to detect positions of structural components of the door opener.

According to another advantageous aspect, the opening is configured as a through-opening. Depending on the composition of the electronic structural components, the entire wall thickness of the printed circuit board can be utilized in order to incorporate electronic structural components into the printed circuit board.

According to another advantageous aspect, the opening is configured as a blind-end hole. The rigidity of the printed circuit board can thus be kept stable.

According to another advantageous aspect a removed partial area of the wall thickness of the printed circuit board forms a portion of the notch. In this case again, the rigidity of the printed circuit board can be maintained.

According to another advantageous aspect the magneto-sensitive sensor consists of a Hall-effect sensor or of a Reed switch. This allows conventional components can be used.

### BRIEF DESCRIPTION OF THE DRAWINGS

Hereinafter, further measures enhancing the invention will be illustrated in more detail in conjunction with the description of preferred embodiments of the invention based on the Figures. In the drawings:

FIG. 1 shows a housing of the door opener in a perspective view;

FIG. 2 shows the housing of the door opener of FIG. 1 in another perspective view;

FIG. 3 shows the housing of the door opener of the FIGS. 1 and 2 in a top view with a partial auxiliary section;

FIG. 4 shows a printed circuit board utilized with the housing of the door opener of FIGS. 1 to 3 in a perspective view;

FIG. 5 shows the printed circuit board of FIG. 4 in a perspective view, while utilizing two sensors;

FIG. 6 shows another embodiment of a printed circuit board in a perspective illustration;

FIG. 7 shows a carrier for accommodating a sensor in a perspective view;

FIG. 8 shows the printed circuit board of FIG. 6 while utilizing four sensors, wherein one sensor is accommodated by the carrier of FIG. 7; and

FIG. 9 shows a partial view along a sectional plane A-A of FIG. 8.

### DETAILED DESCRIPTION OF THE PRESENTLY PREFERRED EMBODIMENTS

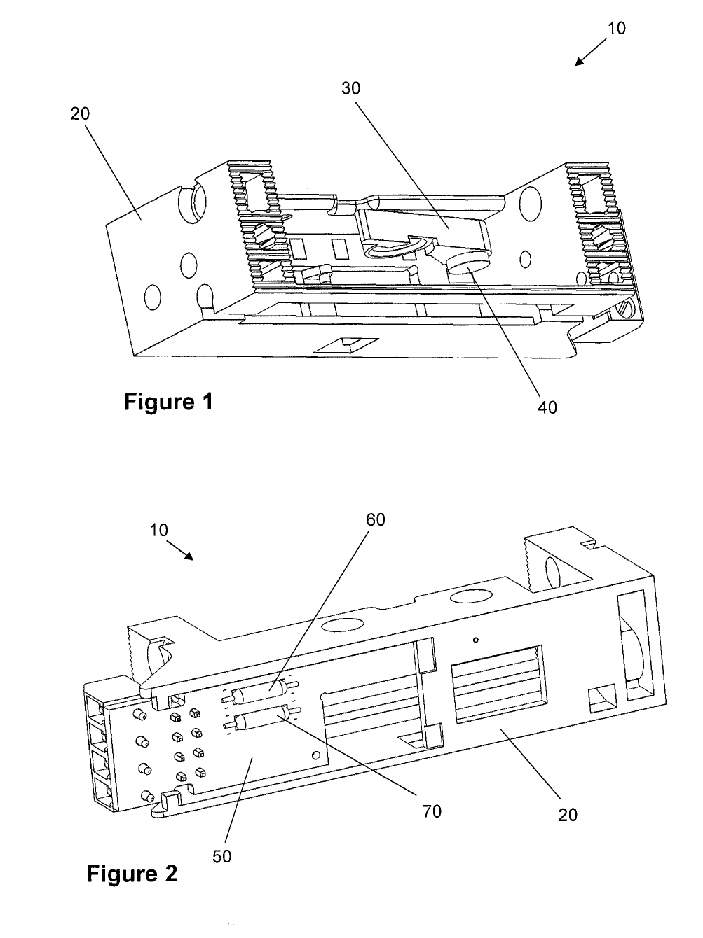

FIG. 1 shows a housing 20 of a door opener 10, in which a structural component 30 is disposed so as to be mobile within the housing 20. The structural component 30 is provided with a magnet 40. In this embodiment, the structural component 30 is configured as a pivotable lever. Further structural components of the door opener 10 are not shown in this view for the sake of clarity, in order to better illustrate and explain the invention.

FIG. 2 shows the housing 20 of FIG. 1 from a another view. The housing 20 is provided with a printed circuit board 50, which has magneto-sensitive sensors 60, 70.

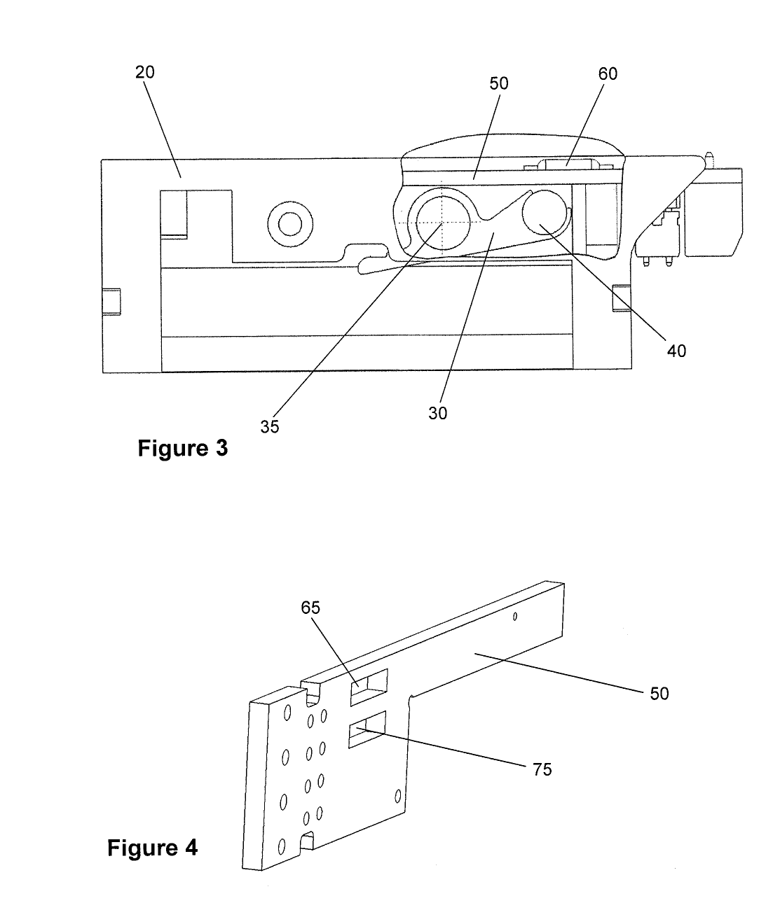

FIG. 3 shows the housing 20 of FIGS. 1 and 2 in a top view, wherein a partial auxiliary section reveals the printed circuit board 50, at which the magneto-sensitive sensors 60, 70 are disposed. In the top view, only the magneto-sensitive sensor 60 is visible. Furthermore, on account of the partial auxiliary section, the structural component 30 is visible, which is disposed so as to be mobile within the housing 20 of the door opener 10. On account of the rotational axis 35, the structural component 30 is disposed to be rotatably supported within the housing 20. At one of its ends, the structural component has a magnet 40.

FIG. 4 shows the printed circuit board 50 including openings 65, 75, which are provided to be able to at least partially accommodate magneto-sensitive sensors 60, 70.

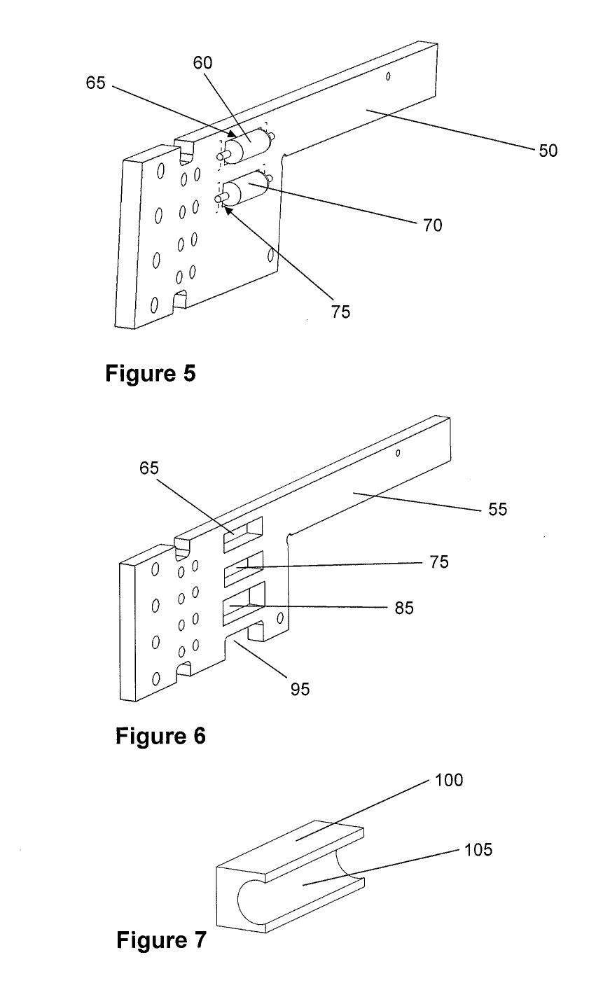

FIG. 5 shows the printed circuit board 50 of FIG. 4, in which a magneto-sensitive sensor 60, by its contacts, is connected to the printed circuit board 50 and protrudes, at least partially, into the opening 65. Another magneto-sensitive sensor 70, by its contacts, is likewise connected to the printed circuit board 50, and protrudes, at least partially, into the opening 75 of the printed circuit board 50.

FIG. 6 shows a printed circuit board 55, which in addition to the openings 65, 75 has another opening 85 and a notch 95, which are provided to at least partially accommodate magneto-sensitive sensors 80, 90, the opening 85 being configured to be larger than the neighboring openings.

FIG. 7 shows a carrier 100, which has a reception 105 for one magneto-sensitive sensor 80, wherein the carrier 100 is configured in such a way that the latter can be introduced into the opening 85 of the printed circuit board 55, and be retained, preferably positively, by the opening.

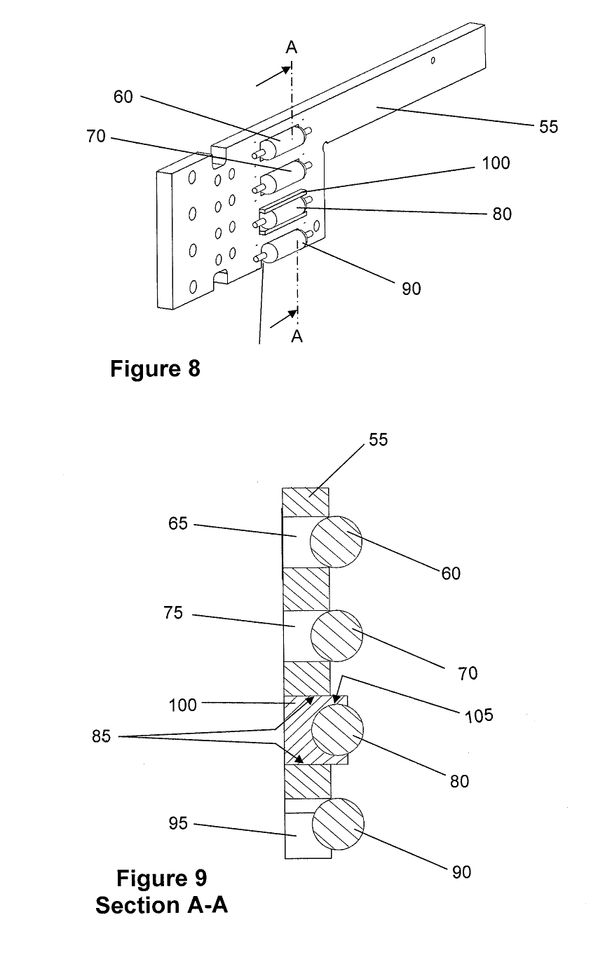

FIG. 8 shows the printed circuit board 55 with the disposed magneto-sensitive sensors 60, 70, 80 and 90, which are connected to the printed circuit board 55. In this case, the magneto-sensitive sensor 80 is retained by the reception 105 of the carrier 100, wherein the carrier 100 is accommodated by the opening 85 of the printed circuit board 55. The magneto-sensitive sensors 60, 70 and 90 protrude, at least partially, into the respective associated openings 65, 75 as well as into the notch 95. The reception 105 of the carrier 100 is configured in such a way that the magneto-sensitive sensor 80 protrudes, at least partially, into the wall thickness of the printed circuit board 55. Furthermore, a sectional plane A-A is indicated in FIG. 8.

FIG. 9 shows a sectional view based on the sectional plane A-A of FIG. 8. The printed circuit board 55 has openings 65, 75, and 85 as well as the notch 95. The magneto-sensitive sensor 60 is disposed in such a way in the printed circuit board 55 that it protrudes, at least partially, into the opening 65. The magneto-sensitive sensor 70 is likewise disposed in such a way at the printed circuit board 55, that it protrudes, at least partially, into the opening 75. The magneto-sensitive sensor 90 is disposed in such a way at the printed circuit board 55, that it protrudes, at least partially, into the notch 95. The carrier 100 is introduced into the opening 85 and is preferably positively retained by the opening 85. It is likewise conceivable within the scope of the invention to establish a non-positive connection between the opening 85 of the printed circuit board 55 and the carrier 100. The reception 105 is configured such that it positively retains the magneto-sensitive sensor 80, wherein the carrier 100 can be configured so as to non-positively retain the magneto-sensitive sensor 80. The carrier 100, with its reception, is configured in such a way that, in the assembled condition together with the printed circuit board 55, the magneto-sensitive sensor 80 protrudes, at least partially, into the wall thickness of the printed circuit board 55.

The invention relates to a door opener 10 including a detector configured to detect relative and/or absolute positions of mobile structural components of the door opener 10. For detecting the exact position of a structural component within the housing 20, a magnet 40 is in operative connection with at least one magneto-sensitive sensor 60, 70, 80, and 90, which is for example configured as a Hall-effect sensor or as a Reed switch. The magneto-sensitive sensor 60, 70, 80, and 90 is likewise disposed at another structural component of the door opener 10, preferably at a printed circuit board 50, 55 or at a conductor foil.

In this embodiment, the magnet 40 is disposed at a structural component 30, for example at a pivotable lever, at a latch or at a latch lever, such that the structural component 30, on account of a rotational axis 35, is disposed to be rotatably supported within the housing 20. The structural component 30 is disposed to be spring-loaded within the housing 20. The magnet 40 is disposed at one end of the structural component 30, and, on account of the rotational support of the structural component 30, is guided on a circular path within the housing 20. The structural component 30, at its other second end, cooperates with a latch-bolt of a lock, which is disposed in a door. Upon opening the door, in which the latch-bolt of the lock leaves the housing 20 of the door opener 10 and thus cancels the operative connection between the latch-bolt and the structural component 30, on account of the spring energy, the structural component 30 is conveyed into a resting position, in which the magnet 40, on the circular path on which it is guided, is guided towards the magneto-sensitive sensor 60, 70, 80, and 90, wherein a small distance exists between the magnet 40 and the magneto-sensitive sensor 60, 70, 80, and 90. This distance is dimensioned such that an operative connection is established from the magnet 40 to the sensor 60, 70, 80, and 90, in such a way that the sensor 60, 70, 80 and 90 detects a signal, which is intended to detect the position of the magnet 40 and thus of the structural component 30, indicating, in this embodiment, that the door must be open. The signal, which is detected in the sensor 60, 70, 80, and 90, is directly forwarded to the printed circuit board 50, 55 via the contacts of the sensor 60, 70, 80, and 90 and is then supplied to corresponding monitoring electronics.

In the event the latch-bolt of the lock abuts within the housing 20 of the door opener 10, in which case the door opener 10 blocks the latch-bolt of the lock and thus the door, the latch-bolt presses a portion of the structural component 30 against the spring energy out of the resting position, wherein the magnet, on its guided circular path, is moving away from the magneto-sensitive sensor 60, 70, 80, and 90. The distance between the magnet 40 and the magneto-sensitive sensor 60, 70, 80, and 90 is thereby increased, which cancels the operative connection between the magnet 40 and the magneto-sensitive sensor 60, 70, 80, and 90. If the distance has increased so much that the operative connection between the magnet 40 and the magneto-sensitive sensor 60, 70, 80, and 90 is cancelled, the sensor 60, 70, 80, and 90 no longer detects any signal, which indicates, in detection of the position of the magnet 40 and thus of the structural component 30, that the door is closed.

The sensor 60, 70, 80 is inserted into openings 65, 75, 85 of the electrical printed circuit board 50, 55 and is connected to the printed circuit board 50, 55. The sensor 60, 70, 80 may be furthermore mounted via a carrier 100 for example by clamping the carrier to the printed circuit board 50, 55. The printed circuit board 50, 55 may also have a notch 95, into which the sensor 60, 70, 80 is inserted and connected to the printed circuit board 50, 55, or is inserted into the printed circuit board 50, 55 and connected to the latter via the carrier 100. In relation to the housing 20, the printed circuit board 50, 55 is firmly mounted via attaching structure. However, as an alternative, the printed circuit board 50, 55 could be a mobile component of the door opener 10.

As the sensor 60, 70, 80, and 90 is almost completely located inside the openings 65, 75, 85 and/or the notch 95 and is retained therein possibly via a carrier 100, the sensor 60, 70, 80, and 90 does not unnecessarily increase the structural height, and, in a very tight space, it is possible to incorporate an inventive precise position detection for one or more mechanical structural components into the door opener 10 without having to invest a lot of additional effort. As in particular indicated in FIG. 9 (section A-A), the sensor 60, 70, 80, and 90 protrudes into the thickness of the printed circuit board 50, 55, whereby the sensor 60, 70, 80, and 90 is almost completely inserted into the thickness of the printed circuit board 50, 55.

As the printed circuit board 50, 55 is disposed at the housing 20 of the door opener 10, a very precise and preferably contactless detection of the relative position of the individual structural components, in this embodiment of the structural component 30, is possible thereby providing a very precise monitoring of the conditions of the door opener 10. The possibilities of monitoring the position of mechanical structural components are multiple. It is possible to equally detect longitudinal and transverse displacements, rotational movements, intermediate positions and terminal positions, without having to significantly modify the door opener 10 and without requiring an enlarged housing 20.

According to the invention, an important consideration is movement of the structural component 30 in relation to the printed circuit board 50, 55 of the door opener 10, wherein the magnet 40 and the sensor 60, 70, 80, and 90 can be brought into operative connection or out of operative connection. As the inventive solution provides the utmost separation of mechanical structural components of the door opener 10 and of the magneto-sensitive sensor 60, 70, 80, and 90 that detect the relative movements of the structural components, the position detection is relatively resistant to damage, impurities and faulty detections on account of incorrect installations.

The sensor 60, 70, 80, and 90, completely mounted on one side of the printed circuit board 50, 55, is easily accessible from the outside and can be repaired or exchanged without difficulty. The occurrence of faulty detection of the positions of the mechanical structural components is significantly reduced, because the printed circuit board 50, 55 and the openings 65, 75, 85, and the notch 95 can be produced with very small manufacturing tolerances and the printed circuit board 50, 55 can be very precisely installed in relation to the housing 20 via the attachment means.

In this embodiment, the carrier 100 preferably consists of a plastic material, the carrier has a reception 105, which is able to accommodate the sensor 60, 70, 80, and 90, and the carrier 100 can be inserted into the opening 85 of the printed circuit board 50, 55 by being clamped to it or pressed into it. As an alternative, the sensor 60, 70, 80, and 90 can be incorporated into the printed circuit board 50, 55 and affixed thereto for example by bonding just like the magnet 40. Other mounting methods, such as a crimp connection, screwed connection or the like are likewise conceivable within the scope of the present invention.

The inventive embodiment is significant in that the space requirement of the additional structural components for detecting the positions of the mobile structural components of the door opener 10 is reduced. The inventive detector may be slightly thicker than the thickness of the proper printed circuit board 50, 55, wherein likewise another structural component of the proper door opener 10 may include the detector. According to another aspect, the structural component may constitute the exterior wall of the proper housing 20 and for example represent or constitute a lower or an upper wall of the housing 20. It is likewise possible to utilize a conductor foil instead of the electrical printed circuit board 50, 55, in order to allow for the utmost cableless connection of the magneto-sensitive sensor 60, 70, 80, and 90 within the door opener 10. A conductor foil requires very little space, and in this case, according to the invention, the sensor 60, 70, 80, and 90 could be directly inserted and incorporated into the existing structural components of the door opener 10.

Another significance of the inventive embodiment is that, on account of the recessed mounted sensor 60, 70, 80, and 90, the sensor 60, 70, 80, and 90 can no longer be damaged by the magnet 40 moving past it.

The preceding description of the present invention serves for illustrative purposes only and is not intended to limit the invention. Various changes and modifications are possible within the range of the invention without leaving the scope of the invention or the equivalents thereof.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-15. (canceled)

16. A door opener (10) comprising:
at least one first printed circuit board (50, 55);
at least one structural component (30) movable in relation to the printed circuit board (50, 55), the at least one structural component being configured to, depending on the functioning of the door opener (10), assume different positions; and
a detector configured to detect a relative and/or absolute position of mobile structural components of the door opener (10),
wherein the detector has at least one magneto-sensitive sensor (60, 70, 80, 90) configured to be accommodated in a carrier (100) of the at least one printed circuit board (55), the at least one magneto-sensitive sensor (60, 70, 80, 90) being at least partially disposed within the printed circuit board (50, 55), contacts of the at least one magneto-sensitive sensor (60, 70, 80, 90) being coupled to the at least one printed circuit board (50, 55), either directly or via a conductor foil, and the at least one magneto-sensitive sensor (60, 70, 80, 90) cooperating with at least one magnet (40) at the structural component (30), which is mobile in relation to the magnet, to generate a position signal.

17. The door opener (10) according to claim 16, wherein the printed circuit board (50, 55) has at least one opening (65, 75) into which the at least one magneto-sensitive sensor (60, 70) protrudes at least partially.

18. The door opener (10) according to claim 16, wherein the magnet (40) is disposed in or at the structural component (30).

19. The door opener (10) according to claim 16, wherein the structural component (30) comprises the magnet (40).

20. The door opener (10) according to claim 16, wherein the at least one magneto-sensitive sensor (60, 70, 80, 90) is configured on the at least one first printed circuit board (50, 55) as an encapsulated sensor in a surface-mounted design.

21. The door opener (10) according to claim 16, wherein the carrier (100) has a reception portion (105) configured to receive the at least one magneto-sensitive sensor (60, 70, 80, 90).

22. The door opener (10) according to claim 16, wherein the printed circuit board (50, 55) has an opening (85) for positively accommodating the carrier (100).

23. The door opener (10) according to claim 16, wherein the carrier (100) is configured to accommodate the at least one magneto-sensitive sensor (80) so that the at least one magneto-sensitive sensor (80) at least partially protrudes into the wall thickness of the printed circuit board (50).

24. The door opener (10) according to claim 16, wherein the carrier (100) consists of a plastic material.

25. The door opener (10) according to claim 16, wherein the printed circuit board (50, 55) defines a notch (95), into which one magneto-sensitive sensor (90) at least partially protrudes.

26. The door opener (10) according to claim 17, wherein the opening (65, 75) is configured as a through-opening.

27. The door opener (10) according to claim 17, wherein the opening (65, 75) is configured as a blind-end hole.

28. The door opener (10) according to claim 25, wherein the notch (95) is defined by a removed partial portion of the wall thickness of the printed circuit board (50, 55).

29. The door opener (10) according to claim 16, wherein the at least one magneto-sensitive sensor (60, 70, 80, 90) is a Hall-effect sensor or a Reed switch.
